(19) United States
(12) Patent Application Publication
(10) Pub. No.: US 2018/0299342 A1
(43) Pub. Date: Oct. 18, 2018

(54) Pinch Valve and Method for Operating a Pinch Valve

(71) Applicant: FESTO AG & Co. KG, Esslingen (DE)

(72) Inventor: Peter Hornung, Aichtal (DE)

(21) Appl. No.: 15/947,283

(22) Filed: Apr. 6, 2018

(30) Foreign Application Priority Data
Apr. 18, 2017 (DE) 102017206533.8

(51) Int. Cl. G01M 3/22; F16K 7/07; F16K 37/00

(52) U.S. Cl. CPC G01M 3/222; F16K 37/0091; F16K 7/07

(57) ABSTRACT

A pinch valve including a tubular valve member, which extends in a valve housing between two connecting pieces having a fluid port each and which has a flexible circumferential wall, and further including a pressurisation chamber, which is arranged in the valve housing around the circumferential wall of the valve member and which can be pressurised by compressed air which can act on the circumferential wall of the valve member as a pinching means in order to pinch it for changing the flow cross-section made available by the valve member for the passage of process medium, and further including a leakage detection device for detecting a leakage causing the escape of process medium at the pinch valve.

### BACKGROUND OF THE INVENTION

The invention relates to a pinch valve comprising a tubular valve member, which extends in a valve housing between two connecting pieces having a fluid port each and which has a flexible circumferential wall, and further comprising a pressurisation chamber, which is arranged in the valve housing around the circumferential wall of the valve member and which can be pressurised by a pressure fluid which can act on the circumferential wall of the valve member as a pinching means in order to pinch it for changing the flow cross-section made available by the valve member for the passage of process medium. The invention further relates to a method for operating a pinch valve.

Such a pinch valve is described in DE 10 2007 006 767 B4, for example. In the pinch valve disclosed there, compressed air is used to compress the flexible circumferential wall.

A different principle of a pinch valve is disclosed in EP 1 912 001 A1, wherein pinching elements which can be moved towards and away from each other at right angles to a valve longitudinal axis are provided for pinching the flexible circumferential wall.

If pinch valves are to be used in the food, pharmaceutical and cosmetics sector as well, they have to meet additional requirements, having to conform to a so-called 3-A standard in particular.

The invention is based on the problem of creating a pinch valve of the type referred to above and/or of providing a method for operating a pinch valve which open up additional applications, in particular the possibility of using the pinch valve in the food, pharmaceutical and cosmetics industries.

### SUMMARY OF THE INVENTION

This problem is solved by a pinch valve comprising a tubular valve member, which extends in a valve housing between two connecting pieces having a fluid port each and which has a flexible circumferential wall, and further comprising a pressurisation chamber, which is arranged in the valve housing around the circumferential wall of the valve member and which can be pressurised by a pressure fluid which can act on the circumferential wall of the valve member as a pinching means in order to pinch it for changing the flow cross-section made available by the valve member for the passage of process medium, and further including a leakage detection device for detecting a leakage causing the escape of process medium at the pinch valve.

The inventive pinch valve is characterised in that a leakage detection device is provided for detecting a leakage causing the escape of process medium at the pinch valve.

With the leakage detection device, which could also be described as a leakage sensing device, a leakage causing the escape of process medium can be detected reliably. Such leakages can, for example, be caused by a crack in the flexible circumferential wall of the valve member, e.g. as a result of material fatigue caused by frequent alternation between compression and reopening. In the food, pharmaceutical and cosmetics industries in particular, various standards stringently demand that leakages are identified reliably. This prevents the contamination of other process regions, e.g. apparatus and plant located there, by the escape of process medium. In addition, any contamination of the process medium by control air is eliminated. As a result a higher degree of process safety can be achieved. Furthermore, if a leakage is detected, the branch with the leaking pinch valve is closed down for replacing the damaged component of the pinch valve. An essential aspect is that with the leakage detection device according to the invention any leakage can be detected in real time, i.e. essentially immediately after the occurrence of the first leakage quantity.

In a further development of the invention, the leakage detection device is configured for the visual identification of escaping process medium. Alternatively or in addition, it is possible that the leakage detection device comprises measuring means for measuring escaping process medium. As measuring means, sensors delivering qualitative and quantitative measuring results can be used, for example, wherein the qualitative measuring results provide an indication whether a leakage quantity of process medium is present, while the quantitative measuring results allow the escaping leakage quantity to be indicated. The measuring results can be transmitted to a higher-level process controller, where they can then be evaluated. It would, for example, be possible to close down the branch with the leaking pinch valve. This can be done automatically or manually by an operator by way of a suitable indication, e.g. a warning.

In the present application, the pressurisation chamber which can be pressurised by pressure fluid relates to the application of compressed air or other gaseous media to the pressurisation chamber. The process medium is in particular a liquid or liquid-like process medium. Other conceivable process media are liquid/solid mixtures, so-called suspensions, and fluid solids, which, in case of a leakage, can also be detected by means of the leakage detection device.

In a particularly preferred way, the leakage detection device comprises a venting device for venting the pressurisation chamber, which venting device is designed such that any process medium escaping in the case of a leakage can be carried along in the venting process by the escaping pressure fluid, in particular compressed air, and conveyed into a venting space. The leakage detection is expediently carried out in the venting space. One advantage of this leakage detection by means of a venting process of a venting device is that a leakage is detected or identified in real time.

In a further development of the invention, the venting device comprises a vent valve.

The vent valve is expediently located on the valve housing of the pinch valve, being in particular secured there by fastening means. In a particularly preferred way, the fastening means comprise components of a flange joint which can be cleaned easily, so that the enhanced hygiene requirements, in particular in the food, pharmaceutical and cosmetics sector, can be met.

In a particularly preferred way, the vent valve is designed as a quick-venting valve. A quick-venting valve offers the advantage that the venting process runs along a relatively short distance and can therefore be carried out quickly.

The venting space can possibly be the environment, i.e. the system is vented into the environment.

It is, however, advantageous that the venting space is designed as a collecting chamber for the escaping process medium. For this purpose, the quick-venting valve can be designed with caught exhaust air, for example.

The collecting chamber is expediently designed as a separating device for separating process medium from the compressed air.

The invention furthermore relates to a method for operating a pinch valve comprising a tubular valve member, which extends in a valve housing between two connecting pieces having a fluid port each and which has a flexible circumferential wall, and further comprising a pressurisation chamber, which is arranged in the valve housing around the circumferential wall of the valve member, the method comprising the following steps:

the pressurisation of the pressurisation chamber with pressure fluid acting on the circumferential wall of the valve member as a pinching means in order to pinch it for changing the flow cross-section made available by the valve member for the passage of process medium, the venting of the pressurisation chamber in order to increase the flow cross-section, the detection of a leakage causing the escape of process medium by means of a leakage detection device.

It is particularly preferred if any process medium escaping in the case of a leakage is carried along in the venting process by the escaping pressure fluid and conveyed into a venting space.

The leakage detection is expediently carried out in the venting space.

A quick-venting valve is expediently used for venting.

### BRIEF DESCRIPTION OF THE DRAWINGS

A preferred embodiment of the invention is shown in the drawing and explained in greater detail below.

FIG. 1 is a longitudinal section through a preferred embodiment of the pinch valve according to the invention in the non-actuated maximum open position, and

FIG. 2 shows the pinch valve from FIG. 1 in the closed position.

### DETAILED DESCRIPTION

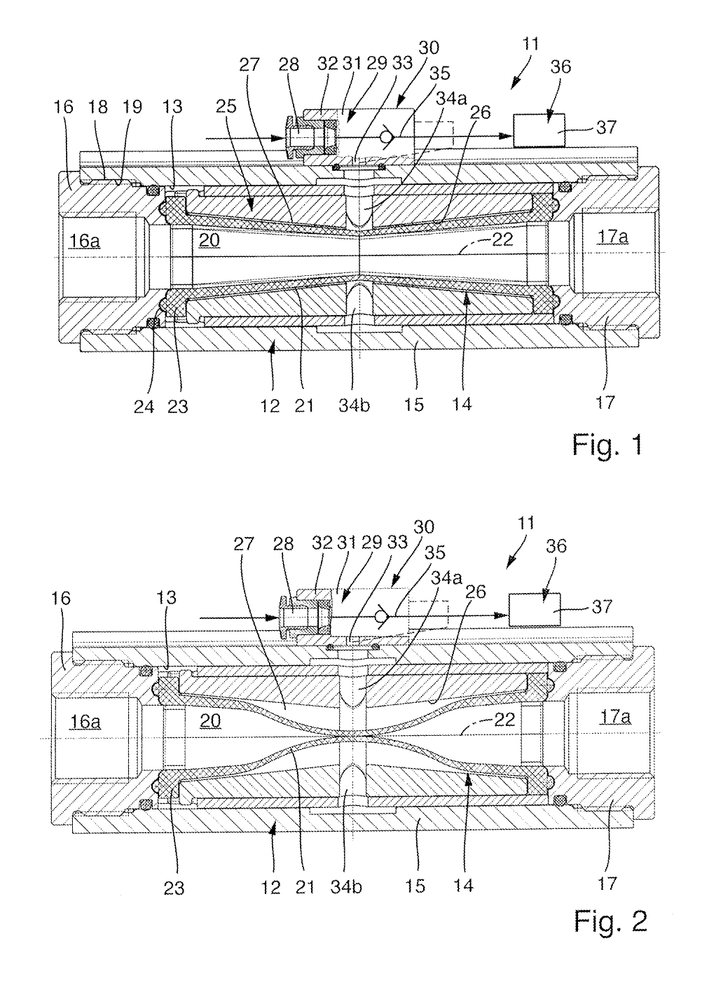

FIGS. 1 and 2 show a preferred embodiment of the pinch valve 11 according to the invention. This has a valve housing 12 defining a housing interior 13, in which a tubular valve member 14 is located.

The valve housing 12 comprises a tubular housing main part 15 and two connecting pieces 16, 17, which are located at opposite end faces, at the same time fulfilling the function of housing covers. A channel-shaped fluid port 16A, 17A passes through each connecting piece 16, 17, preferably coaxially.

At least one of the connecting pieces 16, 17 can be integrated with the housing main part 15. In both cases, however, a separate arrangement is preferred, in particular with releasable mounting on the housing main part 15.

In the illustrated embodiment, the two connecting pieces 16, 17 are bolted to the housing main part 15. The connecting pieces 16, 17 have a male thread 18, by way of which they are tightened into a female thread 19 at the inner circumference of the tubular housing main part 15.

The tubular valve member 14 is a single-piece component in particular and is expediently made of a rubber-elastic material, in particular of an elastomer material. A fluid passage which can be described as valve member passage 20 passes coaxially through. Along the major part of its length, the valve member passage 20 is enclosed by a flexible, in particular rubber-elastic, circumferential wall 21, the longitudinal axis of which coincides with the valve member longitudinal axis 22. At each of its two axial end faces, the valve member 14 terminates in a radially projecting, preferably disc-shaped flange section 23, which is in particular formed integrally with the circumferential wall 21.

The valve member 14 and the two connecting pieces 16, 17 are mutually aligned in such a way that the valve member passage 20 is in alignment with the two channel-shaped fluid ports 16A, 17A. Process medium fed in via one or the other of the fluid ports 16A, 17A can therefore flow through the valve member passage 20 towards the respective other fluid port 17A, 16A and leave the pinch valve 11 via the latter.

Fastening means 16b, 17b assigned to the fluid ports 16A, 17A, for example in the form of female threads, facilitate the fluid-tight connection of a fluid line each, via which the process medium to be controlled can be brought to the pinch valve 11 and removed therefrom.

The valve member passage 20 and the two fluid ports 16A, 17A are in particular aligned coaxially with one another.

In order to ensure a sealed connection between the valve member 14 and the two connecting pieces 16, 17, the two flange sections 23 are each firmly clamped to the respective facing end face of the adjacent connecting piece 16, 17 by their opposite outer end faces 24 while forming a seal.

In order to clamp the valve member 14 axially between the two connecting pieces 16, 17, a rigid supporting tube 25 is coaxially arranged around the tubular circumferential wall 21 according to the illustrated embodiment.

The supporting tube 25 is used for the radial support of the flexible circumferential wall 21. The latter extends through the tubular passage 26 defined by the supporting tube 25 and can be pressed in a radially outward direction against the supporting tube wall 27 defining the tubular passage 26 by the process medium flowing in the valve member passage 20. A radial expansion of the valve member 14 in the region of the circumferential wall 21 is therefore possible only as far as the supporting tube wall 27 allows.

The annular space provided radially between the supporting tube 25 and the circumferential wall 21 of the valve member 14 surrounding it forms a pressurisation chamber 27 provided for the application of pressure fluid. Into this pressurisation chamber 27, pressure fluid, in the illustrated embodiment compressed air, which acts directly on the circumferential wall 21 as pinching means and compresses it radially to a greater or lesser degree depending on pressure, can be fed via a control port 28 located on the outside of the valve housing 12.

In order to use the pinch valve 11 according to the invention in industrial sectors setting enhanced hygiene requirements, the pinch valve 11 according to the invention is equipped with a leakage detection device 29 for detecting a leakage causing the escape of process medium at the pinch valve 11.

The leakage detection device 29 comprises a venting device 30 for venting the pressurisation chamber 27; in the illustrated embodiment, this is designed as a quick-venting valve.

The quick-venting valve comprises a quick-venting valve housing 32, which is fitted to the valve housing 12. The quick-venting valve expediently is an integral part of the pinch valve 11. A suitable means for mounting the quick-venting valve is a flange joint (not shown), which meets the demanded hygiene requirements, being easy to clean in particular.

As FIG. 1 in particular shows, the control port 28 is located at the quick-venting valve housing 32. As FIGS. 1 and 2 furthermore show diagrammatically, the quick-venting valve has, in addition to the control port 28, which could also be described as inlet port and via which compressed air can be fed in, an outlet port 33, which in the illustrated embodiment is located on the underside of the quick-venting valve housing 32 and connected to the fluid through-passages 34a, 34b formed in the supporting tube wall 27. The fluid through-passages 34a, 34b in turn terminate into the pressurisation chamber 27.

The quick-venting valve furthermore has a venting port 35. In the quick-venting valve housing 32, there is furthermore provided a closing member, e.g. in the form of a valve disc (not shown), which is shown purely diagrammatically in FIGS. 1 and 2 and which, depending on its position within the quick-venting valve housing 32, either closes off the venting port 35 in the housing interior and allows a flow from the control port to the outlet port 33 or closes the inlet or control port and then allows a flow from the outlet port 33 to the venting port 35, permitting venting.

Such a quick-venting valve is, for example, disclosed in DE 78 34 047 U1, to which we refer here to the full extent.

As FIGS. 1 and 2 in particular show diagrammatically, a venting space 36, which in the illustrated embodiment is realised as a collecting chamber in the form of a separation device 37, is located downstream of the venting port 35. The separation device 37 or separator can, for example, have a sight glass through which process medium in the separator can be detected, allowing a conclusion regarding a leakage at the pinch valve 11.

An essential aspect of the leakage detection device 29 is that the venting device with its quick-venting valve conveys in the venting process any process medium escaping in the case of a leakage by means of the compressed air into the venting space 36, where it can then be detected as separated process medium.

FIG. 2 shows the closed position of the pinch valve 11. Here, the compressed air fed into the pressurisation chamber 27 with positive pressure has pinched the circumferential wall 21 until radially opposite wall sections of the circumferential wall 21 are in tight contact with one another. This blocks the flow cross-section through the valve member passage 20.

For venting, the supply of compressed air via the control port 28 is first interrupted, as a result of which the valve member in the quick-venting valve, i.e. the valve disc for example, moves owing to the pressure conditions arising then and blocks the control port 28, while the venting port 35 is opened up. As a result, the pressurisation chamber 27 is relieved, because compressed air escapes into the venting space 36 via the venting port.

If there is a leakage, which mainly involves a crack in the flexible circumferential wall 21 of the valve member 14, allowing process medium flowing in the valve member passage 20 to escape through the circumferential wall 21, the escaping process medium is entrained by the compressed air and enters the venting space 36, in the illustrated embodiment the separator, together therewith, where it is then separated. The compressed air freed of process medium then escapes into the environment.

The leakage can therefore already be located after the first switching cycle of the pinch valve 11, i.e. between the closed position and a pressure-relieved open position, because escaping pressure medium is entrained by the compressed air in the venting process. A leakage can then be detected visually in a simple way via the sight glass of the separator. It is obviously possible to provide a sensor instead of the sight glass; this would output a sensor signal taken as a measure for the presence of a leakage if separated process medium is detected.

In a variant not shown in the drawing, measuring means for measuring the escaping process medium can be provided. Such measuring means can, for example, be a probe which qualitatively detects the presence of process medium in the compressed air escaping in the venting process. Alternatively, sensors could be used for measuring a leakage quantity of escaping process medium. The measuring results of the measuring means can be transmitted to a higher-level process controller, where they are then evaluated. It is, for example, possible that the measuring means are a part of an open- or closed-loop process control, so that the branch with the leak-affected pinch valve 11 is automatically closed down. Alternatively, it would, however, also be possible to transmit the measuring signals to a monitoring centre, where they can then be indicated, so that the operator can initiate suitable actions, such as the shut-down of the branch with the leak-affected pinch valve 11.

What is claimed is:

1. A pinch valve comprising a tubular valve member, which extends in a valve housing between two connecting pieces having a fluid port each and which has a flexible circumferential wall, and further comprising a pressurisation chamber, which is arranged in the valve housing around the circumferential wall of the valve member and which can be pressurised by a pressure fluid which can act on the circumferential wall of the valve member as a pinching means in order to pinch it for changing the flow cross-section made available by the valve member for the passage of process medium, and further comprising a leakage detection device for detecting a leakage causing the escape of process medium at the pinch valve.

2. The pinch valve according to claim 1, wherein the leakage detection device is configured for the visual identification of escaping process medium.

3. The pinch valve according to claim 1, wherein the leakage detection device comprises measuring means for measuring escaping process medium.

4. The pinch valve according to claim 3, wherein the measuring means are coupled to a process controller for processing the measuring results.

5. The pinch valve according to claim 1, wherein the leakage detection device comprises a venting device for venting the pressurisation chamber, which venting device is designed such that any process medium escaping in the case of a leakage can be carried along in the venting process by the escaping pressure fluid, and conveyed into a venting space.

6. The pinch valve according to claim 5, wherein the venting device comprises a vent valve.

7. The pinch valve according to claim 6, wherein the vent valve is secured on the valve housing by fastening means, the fastening means comprising components of a flange joint.

8. The pinch valve according to claim 6, wherein the vent valve is designed as a quick-venting valve.

9. The pinch valve according to claim 5, wherein the venting space is the environment.

10. The pinch valve according to claim 5, wherein the venting space is designed as a collecting chamber for the escaping process medium.

11. The pinch valve according to claim 10, wherein the collecting chamber is designed as a separating device for separating process medium from the compressed air.

12. A method for operating a pinch valve comprising a tubular valve member, which extends in a valve housing between two connecting pieces having a fluid port each and which has a flexible circumferential wall, and further comprising a pressurisation chamber, which is arranged in the valve housing around the circumferential wall of the valve member, the method comprising the following steps:
the pressurisation of the pressurisation chamber with pressure fluid acting on the circumferential wall of the valve member as a pinching means in order to pinch it for changing the flow cross-section made available by the valve member for the passage of process medium;
the venting of the pressurisation chamber in order to increase the flow cross-section; and
the detection of a leakage causing the escape of process medium by means of a leakage detection device.

13. The method according to claim 12, wherein process medium escaping in a leakage is entrained by the escaping pressure fluid in the venting process and conveyed into a venting space.

14. The method according to claim 13, wherein the leakage detection is carried out in the venting space.
